(19) United States
(12) Patent Application Publication
(10) Pub. No.: US 2010/0082399 A1
(43) Pub. Date: Apr. 1, 2010

(54) SYSTEMS AND METHODS FOR DISTRIBUTING ADVERTISEMENTS IN A NETWORK-BASED ENVIRONMENT

(75) Inventors: Arpita Ghosh, Santa Clara, CA (US); Serguei Vassilvitskii, New York, NY (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(73) Assignee: YAHOO! INC., Sunnyvale, CA (US)

(21) Appl. No.: 12/240,549

(22) Filed: Sep. 29, 2008

(51) Int. Cl. G06F 17/30; G06Q 30/00; G06Q 40/00; G06Q 10/00; G06Q 90/00

(52) U.S. Cl. 705/10; 705/37; 705/7; 705/14.53

(57) ABSTRACT

The present invention is directed to a system and method for distributing advertisements in a network-based advertisement campaign. The method and system includes determining a number of advertisement placements for a contract within a contract time interval where the advertisement placements may be presented to users having defined characteristics. The method and system includes reviewing forecasting information regarding user traffic, including forecasting information for predicting a volume of users having the defined characteristics. The method and system includes, in response to the forecasting information, procuring advertisement placements consistent with the contract during the contract time interval and distributing the advertisements in a network-based output.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The present invention relates generally to advertising more specifically to the distribution of advertisements in a network-based environment.

### BACKGROUND OF THE INVENTION

Since the widespread acceptance of the Internet, advertising as a main source of revenue has proven to be both effective and lucrative. Advertising on the Internet provides the additional benefit of allowing advertisers to more effectively target audiences viewing their advertisements as opposed to traditional print and “hard copy” advertising which constitute a one-way flow of information: advertisers to users.

The very nature of the Internet facilitates a two way flow of information between users and advertisers and allows these transactions to be conducted in real time or near-to-real time. For example, a user may request an ad and may intentionally, or inherently, transmit various pieces of data describing himself or herself. Additionally, an advertising management system may be able to intelligently determine which ads to place on a given website requesting advertisement content, increasing the revenue for both parties involved and increasing user satisfaction by eliminating “nuisance” ads, or those ads in which a user is not interested.

The current state of the art, however, fails to fully exploit the interactive aspects of the Internet in the advertising realm. Most current advertising systems need to coordinate a number of components such as components for forecasting web traffic, targeting demographics, procuring ad placements and publishing ads. Each component relies on the cooperative and reliable performance of the others.

Unfortunately, current advertising systems are decoupled. A decoupled system results in a number of inconsistencies with respect to contracts for the placement and delivery of advertisements. Even just a slight overestimation of future web traffic may jeopardize an advertising system's ability to deliver the advertisements promised. Likewise, an underestimation hurts advertisers and publishers alike because of lost opportunities for ad placements.

Current systems create a strict and artificial separation between display inventory of available advertisement placements that is sold many months in advance in a guaranteed fashion (guaranteed delivery), and inventory that is sold in using a real-time auction in a market or through other means (non-guaranteed delivery). For instance, the Yahoo! ® advertising system may serve guaranteed contracts their desired quota before serving non-guaranteed contracts, creating an unnecessary and inefficient bias toward guaranteed contracts. While acceptable in the past, the shift in the advertising industry demands a mix of guaranteed and non-guaranteed contracts.

Another flaw with the decoupled advertising system is the failure to take advantage of the stores of information available when pricing contracts and allocating advertisements to advertisement placements. For example, the current pricing systems only use advertising information and contract information at a coarse and untargeted level. The failure to mine and use information regarding how advertisement placements may be allocated at a more granular level creates a gap between the price paid for an advertisement placement and the actual value that a contract derives from the advertisements placed.

This failure leads to the inability to provide more refined and targeted advertisements. Increased refinement in targeting allows advertisers to reach a more relevant customer base. The frustration of advertisers moving from broad targeting parameters (e.g., “1 million Yahoo! Finance users) to more fine-grained parameters (e.g., “100,000 Yahoo! Finance users from September 2008-December 2008 who are California males between the ages of 20-35 working in the health care industry”) is evident. Unfortunately, the increased refinement and targeting is simply not computationally pragmatic with the current system design.

Accordingly, there exists a need for a more unified marketplace for the allocation and distribution of advertisements in a network-based environment to increase the probability of satisfying contracts for placing advertisements.

### SUMMARY OF THE INVENTION

The present invention is directed to a system and method for distributing advertisements in a network-based advertisement campaign. The method and system includes determining a number of advertisement placements for a contract within a contract time interval where the advertisement placements may be presented to users having defined characteristics. The method and system includes reviewing forecasting information regarding user traffic, including forecasting information for predicting a volume of users having the defined characteristics. The method and system includes, in response to the forecasting information, procuring advertisement placements consistent with the contract during the contract time interval and distributing the advertisements in a network-based output.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates one embodiment of a system for distributing advertisements in a network-based environment;

FIG. 2 illustrates a flowchart of one embodiment of a method for distributing advertisements in a network-based environment;

FIG. 3 illustrates a flowchart of one embodiment of a method for distributing advertisements in a network-based environment in a substantially uniform manner;

FIG. 4 illustrates a flowchart of one embodiment of a method for monitoring the procuring of advertisement placements consistent with a contract over a contract duration; and

FIG. 5 illustrates a sample output display that the system and method for distributing advertisements in a network-based environment generates.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

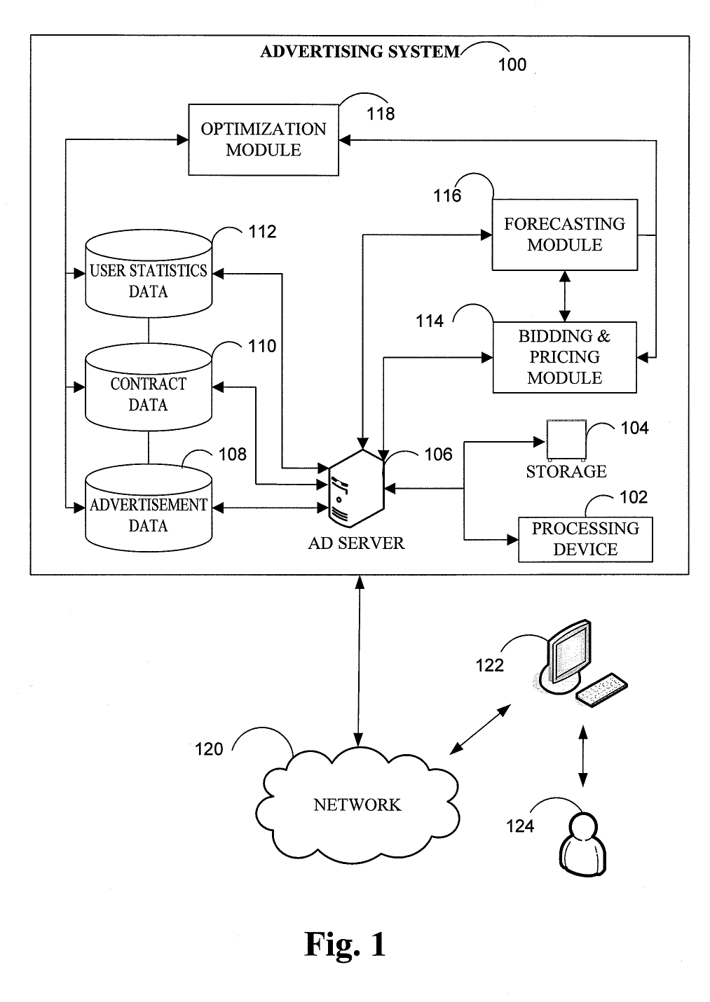

FIG. 1 illustrates an advertising system 100 including a processing device 102, a storage device 104 and an ad server 106. The advertising system 100 further includes an advertisement data store 108, a contract data store 110 and a user statistics data store 112. The advertising system further includes a bidding and pricing module 114, a forecasting module 116 and an optimization module 118. FIG. 1 also illustrates a network 120, a network-based output 122, and user 124.

The processing device 102 may be any suitable type of processing device operative to perform processing operations in response to executable instructions, wherein the executable instructions provide for processing operations as described in further detail herein. The storage device 104 may be any suitable type of storage device operative to store the executable instructions on a computer readable medium such that upon transmission to the processing device 102, the processing device 102 is operative to perform the processing operations as described herein.

The ad server 106 may be one or more server devices operative to perform server operations, including interfacing with the advertisement data store 108, the contract data store 110, the user statistics data store 112, the bidding and pricing module 114, the forecasting module 116 and an optimization module 118. The ad server 106 computer may be further operative to receive and transmit information over a network 120 to users 124 through the network-based output 122.

In one embodiment, the ad server 106 may be operative to establish and manage communication among and between a plurality of hardware devices, data stores, modules, networks, network-based outputs, and users. This communication may utilize communication protocols and/or techniques consistent with knowledge of one skilled in the art. In one embodiment, the ad server 106 may be a plurality server processing devices managing Internet connectivity between users, such as, for example a publicly available Internet search engine, where user 124 accesses a web site for search request operations.

In another embodiment, the ad server 106 may receive a query from an advertiser with contract terms specifying a target. For example, the query may specify Yahoo! finance users who are California males with an interest in sports and autos. The ad server 106 may return the available advertisement placements for the specified target and a contract price. An advertiser may then book the contract through an interface presented on the network-based output 122. With the contract stored in the contract data store 110, the ad server 106 may receive an advertisement opportunity over the network 120. The advertisement opportunity may include a user, information about of the user, a URL of the webpage being accessed by the user and the like. The ad server 106 may then send an advertisement with the amount that the advertiser is willing to pay to the bidding and pricing module 114. The bidding and pricing module 114 may then determine to place the advertisement in the advertisement placement presented by the opportunity.

The advertisement data store 108 may include advertising information usable by the advertising system 100 for distributing advertisements to network-based outputs. The advertisement data store 108 may be any number of databases or data storage devices having advertising information therein. Advertising information may include, but is not limited to, an advertisement plan, advertisement content or media, advertisement metadata, advertiser information, publisher information, advertisement placements, advertisement opportunities and advertisement performance analytics. Additionally, the ad server 106 may include additional processing operations or procedures relating to the selection of particular ads and the placement of those ads in network-based outputs, wherein the selection of the particular advertisement may be aided by the processing operations of the processing device 102 in performing processing steps using information from any of the data stores 108, 110, 112 or modules 114, 116, 118 in communication with the advertising system.

The contract data store 110 may include contracting information usable by the advertising system 100, the contracting information relating to terms and conditions for the placement of a number of advertisement placements as requested by the advertiser. The contract data store 110 may be any number of databases or data storage devices having a plurality of contracts, contract requirements, marketing information, etc. Additionally, the ad server 106 may include additional processing operations or procedures relating to the procurement of advertisement placements consistent with the requirements of a given contract. For example, the additional operations or procedures may include receiving a contract time interval and targeting a demographic of users having defined characteristics.

The user statistics data store 112 may include user statistics information usable by the advertising system 100 in forecasting network traffic, traffic volume for users having defined characteristics, and associated advertising information. The user statistics data store 112 may be any number of databases or data storage devices having user information usable for various purposes, including predicting a volume of users having defined characteristics. Additionally, the ad server 106 may include additional processing operations or procedures relating to the periodic or dynamic updating of user statistics information, the addition of new users, network traffic, demographic and historical information.

The optimization module 118 may include any number of optimizing processes or procedures implemented in software or hardware, or a combination thereof. The optimization module 118 may be operative to receive information from and transmit information to the advertisement data store 108, the contract data store 110, the user statistics data store 108, and the ad server 106. Through the ad server 106, the optimization module 118 may be placed in communication with users on a network-based output 122 through the network 120.

The optimization module 118 may be further operative to be in communication with the bidding and pricing module 114 as well as the forecasting module 116. When in communication with the forecasting module 116, the optimization module 118 may be operative to periodically or dynamically receive forecasting information comprising a number of future advertisement placements or impressions, actual contract information and a prediction of future contracts. The optimization module 118 may be further operative to process information for determining an advertising plan.

In one embodiment, an advertising plan comprises the allocation and distribution of advertisements to the advertisement placements predicted. A summary of the advertisement plan may be transmitted to the ad server 106 and to the bidding and pricing module 114. The advertisement plan may be updated periodically or dynamically on the basis of receiving additional forecasting information or additional information regarding network traffic. Given a plan, the ad server 106, upon receiving an advertisement opportunity may calculate the contention among contracts, to be described in more detail below. When used in combination with the forecasting information, information stored in data stores 108, 110, 112, and the contention information, the ad server 106 may select a contract and generate a bid for the contract in an effort to procure an advertisement placement presented by an advertisement opportunity.

In one embodiment, the advertising plan is periodically or dynamically updated and transmitted to the forecasting module 116, bidding and pricing module 114 and the ad server 106.

The forecasting module 116 may include any number of forecasting processes or procedures implemented as software or hardware, or a combination thereof. The forecasting module 116 may be operative to determine the current availability of advertisement placements given any number of parameters. Some of those parameters may include user characteristics, marketing information and contract time intervals. In one embodiment, the forecasting module 116 uses a scalable multi-dimensional database indexing technique, such as bit-map indexing, for capturing and storing correlations between any number of user characteristics.

The forecasting module 116 may be further operative to determine contention between multiple contracts in the contract data store 110. In one embodiment, the forecasting module 116 may generate a sample data set, for example, impression samples, to determine contention between contracts as well as the number of contracts that may be satisfied. Forecasting information may be communicated to any number of suitable locations, such as the optimization module 118, the bidding and processing module 114, or to users 124 through the network 120 for additional processing.

The bidding and pricing module 114 may include may include any number of processes or procedures implemented as software or hardware, or a combination thereof. The bidding and pricing module 114 may be in communication with the advertisement data store 108, the contract data store 110, the user statistics data store 112, the optimization module 118, the forecasting module 116, the ad server 106 or with any number of users 124 through the network 120.

In one embodiment, the bidding and pricing module 114 is operative to update advertiser bids and prices for advertisement placements, automatically or otherwise. In one example, the bidding and pricing module 114 automatically calculates and updates an advertiser's bid or the price for an advertisement placement at a fixed time interval. The bidding and pricing module 114 may also be operative to receive notification from the optimization module 118 to update bidding and pricing information in response to distributing an advertisement or receiving advertisement placement opportunity. In addition, the bidding and pricing module 114 may be operative calculate and update the bids or prices for advertisement placements to be presented to a user having defined characteristics.

The preceding updates may be in response to a change in a bid from another advertiser for the user having similar characteristics. The preceding updates may also be in response to a variance between forecasting information regarding user traffic or the volume of users having defined characteristics and the actual user traffic or volume of users as they are received by the advertising system 100.

The network 120 may include any communications network (e.g., a wired/wireless LAN/WAN, a cellular network, the Internet, an intranet, a social network, a VPN, a PSTN, a VoIP, etc.). The network-based output 122 may include a general purpose personal computer comprising a processor, transient and persistent storage devices, input/output subsystem and bus to provide a communications path between components comprising the general purpose personal computer. Other network-based outputs are considered to fall within the scope of the present invention including, but not limited to, hand held devices, set top terminals, mobile handsets, PDAs, etc.

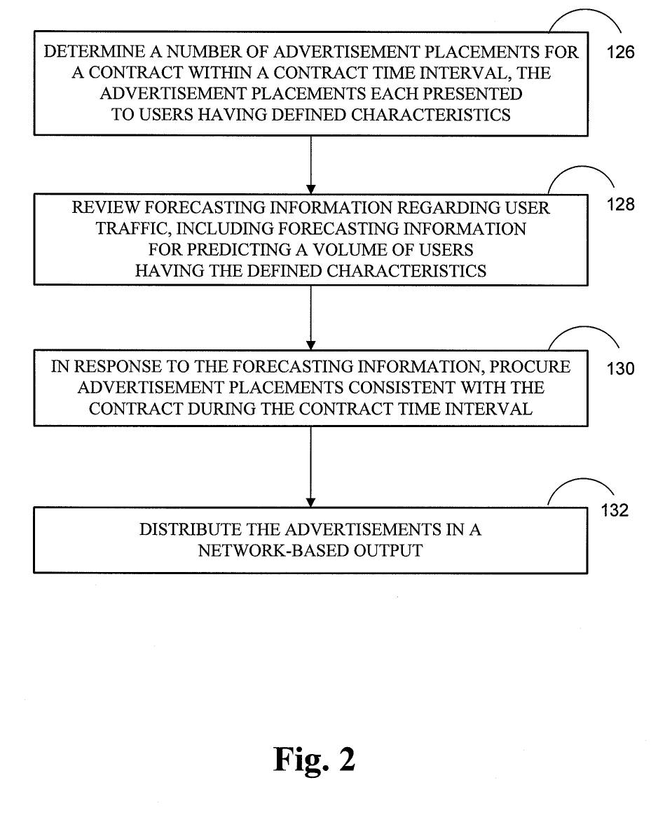

FIG. 2 illustrates a flowchart of one embodiment of a method for distributing advertisements in a network-based environment, such as the system 100 of FIG. 1. The method includes, step 126, determining a number of advertisement placements for a contract within a contract time interval. As noted above, advertisement placements may be presented to users 124 having defined characteristics.

The next step, step 128, is reviewing forecasting information regarding user traffic, including forecasting information for predicting a volume of users having the defined characteristics. This step may be performed by accessing any of the data stores 108, 110, 112 while in communication with the bidding and pricing module 114, the optimization module 118 and the ad server 106. In one embodiment, step 128 includes reviewing information from users in communication with the advertising system 100.

In response to the forecasting information, the next step, step 130, is procuring advertisement placements consistent with the contract during the contract time interval. This bidding may be performed using a bidding module that adjusts a bidding algorithm to account for uncertainty in the forecasting information, including dynamically adjusting a buffer number of procured advertisement placements relative to a number of procured of advertisement placements and a time remaining of the contract time interval. The buffer number of procured advertisements provides a buffer amount of procured placements when tracked relative to the number of impressions to be acquired and the contract duration, whereby the buffer number can be dynamically adjusted based on the factors of the number of procurements to be acquired, the forecasting information and the duration left in the contract. Therefore, this accounts for uncertainty in the supply of available impressions (e.g. user traffic) as well as the probabilistic nature of the bidding algorithm itself such that there is a significant increase in the probability of properly meeting the terms of the advertisement contracts.

This step may be performed by the bidding and pricing module 114 alone, or in communication with the ad server 106. With reference back to FIG. 1, bidding and pricing module 114 is operative to update advertiser bids and prices for advertisement placements, automatically or otherwise. More specifically, the bidding and pricing module 114 engages in an open-bidding system by placing bids on the chance to insert advertisements onto output displays, where the pricing portion of the module includes determining the operative to value to place in the bid itself, which increases a likelihood of winning the bid. It is recognized that in the open bidding system, the module 114 is placing bids against any number of competing entities looking to also place advertisements.

In addition, procuring advertisement placements may be accomplished through any number of advertising techniques, including but not limited to, the placement of impression-based advertisements, click-through and/or conversion-based advertisements. Other advertising techniques will be apparent to those having skill in the art.

The next step, step 132, is distributing the advertisements in a network-based output. This step may be accomplished by placing the ad server 106 in communication with the advertisement data store 108 for the selection of any number of advertisements delivered over the network 120 to a user via a network-based output 122. In addition, advertisements may be distributed according to an advertisement plan from optimization module 118 and in accordance with the requirements of a given contract. A distributed advertisement may comprise any number of media formats, including but not limited to, text, image, audio, video, etc.

In one embodiment, an advertisement may be distributed by embedding executable instructions on a webpage for presentation to a user. Embedding an advertisement may be implemented using various programming languages such as java and javascript, alone or in combination with, markup languages such as HTML and XML and extensions thereof. Other implementations for distributing advertisements will be apparent to those skilled in the art.

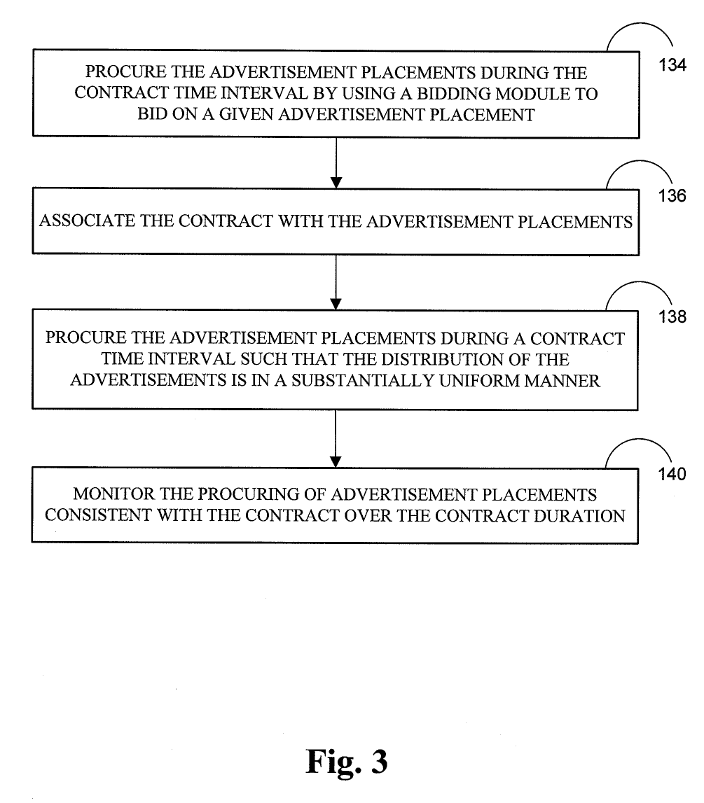

FIG. 3 illustrates a flowchart of one embodiment of a method for distributing advertisements in a network-based environment in a substantially uniform manner. Uniform distribution may include a desire for the allocation of advertisement placements to be substantially uniform over a temporal factor, a geographic factor, a demographic factor, or a combination of factors. Other factors will be apparent to those skilled in the art.

With reference back to step 130 of FIG. 2, the first step in FIG. 3, step 134, adds using a bidding module to bid on a given advertisement placement. In one embodiment, the bidding module is in communication with the optimization module 118 and the forecasting module 116. In addition, the bidding module receives forecasting information comprising an estimate number of available advertisement placements; the advertisement placements may also include the defined characteristics of the users. With advertising plan and forecasting information, the bidding module determines a bid amount for bidding on a given advertisement placement, step 134.

The next step is associating the contract with the advertisement placements, step 136. This step may be performed by referencing the index or catalog of advertisement contracts and the terms or conditions for each contract. Based on a comparison of the advertisement opportunity and the contracts terms, an advertisement contract is designated for fulfillment of the advertisement opportunity and the corresponding information advertisement information associated with the contract is then made readily available for the purpose of being presented in an advertisement (e.g. the ad “copy.”)

The next step is procuring the advertisement placements during a contract time interval such that the distribution of the advertisements is in a substantially uniform manner, as defined above. In one embodiment, the bidding and pricing module 114 accomplishes the procurement in accordance with information in an advertising plan comprising an allocation of advertisements to a particular set of advertisement placements during a contract time interval received from the optimization module 118. In the embodiment of the method illustrated in FIG. 3, the last step is monitoring the procurement of advertisements consistent with the contract during the contract duration, step 140.

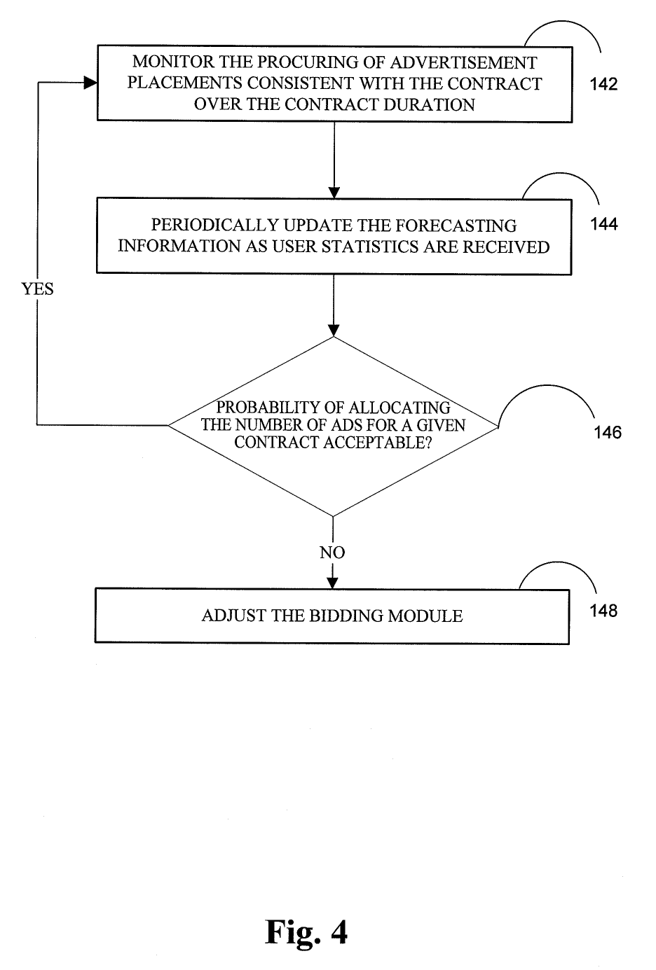

FIG. 4 illustrates a flowchart of one embodiment of a method for monitoring the procuring of advertisement placements. The method includes, step 142, monitoring the procuring of advertisement placements consistent with the contract over the contract duration. In one embodiment, this may include keeping an ongoing count of the number of advertisements, the time duration of the contract and the total requested number of advertisements under the terms of the contract. This may further include account for forecasting data to augment the monitoring of advertisement placements relative to the traffic data for displaying the advertisement in a uniform manner. The next step, step 144, is periodically updating the forecasting information as user statistics are received. The forecasting information may be updated based on ongoing traffic monitoring, and the updating procedures may be performed using known traffic forecasting techniques.

If the probability of allocating the number of ads for a given contract is acceptable, step 146, then the method continues monitoring the procuring of advertisement placements consistent with the contract over the contract duration, step 142. If the check performed at step 146 returns an unacceptable probability, the next step is adjusting the bidding module for the given contract, step 148. The unacceptable probability may be a result of a number of factors including but not limited to, an initial overestimation of network traffic in the forecasting information, an unexpected increase in the amount of contention for advertisement placements directed to users having defined characteristics, or a requirement for a substantially uniform distribution combined with either the underestimation of users or the unexpected contention between contracts, or both.

Adjusting the bidding module is more logical with an understanding of the sources of randomness in advertising systems, the bidding module's probabilistic nature and the need for uniform distribution. In general, there are two sources of randomness. One is the number of predicted advertisements placements in forecasting. The second is a randomized bidding algorithm. In one embodiment, the ad server 106 receives a target T, a random number of available advertisement placements N with a distribution F. To minimize a uniform delivery metric, the ad server 106 chooses a slope p=T/n.

To minimize at the median distribution of N, the ad server 106 may employ an algorithm to choose the n that minimizes:

$${\sum }_{N} f ( N ) \vert ( \frac{TN}{2} - \frac{Tn}{2} ) \vert \qquad ( 1 )$$

where the uniform delivery metric is minimized at the median distribution of N. In another embodiment, the ad server 106 may choose the n that minimizes:

$${\sum }_{N} f ( N ) {( \frac{T}{N} - \frac{T}{n} )}^{2} \qquad ( 2 )$$

where the uniform delivery metric is minimized at 1/E[1/N]. Now assume the bidding module algorithm may purchase fractional advertisement placements while meeting the target with high probability with respect to randomness in supply. Let U

$$( \frac{T}{n} )$$

denote the temporal uniformity metric when the slope is

$$( \frac{T}{n} ) .$$

Let T_{N} denote advertisement placements won when supply is N. The problem for the bidding and pricing module 114 is choosing n to minimize

$$U ( \frac{T}{n} )$$

subject to Pr(T_{N}<)<∈. The solution is as follows: Let N⁻ be the largest number with Pr(T_{N}<T)≦∈. If any fractional advertisement placements are scheduled to be won beyond N⁻, the ad server 106 under-delivers with probability greater than ∈. The reformulation then chooses n to minimize

$$U ( \frac{T}{n} ) ,$$

subject to n≦N⁻. The ad server 106 may then employ an optimal bidding strategy using the model: Toss a coin with bias T/min(N* , N⁻) to meet the target with high probability with respect to the available advertisement placements and maximize temporal uniformity.

Next, achieving a high probability with respect to the algorithm employed by the ad server 106 may be accomplished by the following steps. Assume n coin tosses with probability p. Given Xₙ is the total number of heads,

E[Xₙ]=μₙ=np

A Chernoff bound distribution is applied and yields exponentially decreasing bounds on the tail distributions of the independent random variables. For this computation, the Chernoff bound distribution may be represented as:

$$Pr ( {X}_{n} < ( 1 - δ ) {μ}_{n} ) < exp ( \frac{- {μ}_{n} {δ}^{2}}{2} )$$

If the predicted number of advertisement placements were deterministic and equal to N, the algorithm would set

$$δ = 1 - \frac{T}{{μ}_{n}} .$$

The algorithm would then choose p to solve:

$$n {p ( 1 - \frac{T}{n p} )}^{2} = 2 log ( \frac{1}{∈} ) . \qquad ( 3 )$$

Putting the bidding module's algorithm together, we may then determine the actual probability guarantee with respect to randomness in the predicted number of advertisement placements. First, we observe:

$${δ}_{n} = 1 - \frac{T}{n p}$$

Next, we calculate the right-hand side in the Chernoff distribution with:

$$f ( P ) = {\sum }_{n} Pr ( n ) exp ( - \frac{{μ}_{n} {δ}_{n}^{2}}{2} ) . \qquad ( 4 )$$

There are now three alternatives for probability, a probability that underestimates, a probability that overestimates and one that is exact. To underestimate, choose probability

$${p}_{1} = \frac{T}{{N}^{-}}$$

in which case the algorithm includes a fixed number of advertisement placements, N⁻. To overestimate, compute p₂ to solve equation (3) mentioned above, with n=N⁻. To calculate the exact probability, compute the actual probability p* as a solution to f(p*)=∈. With these calculations, the ad server 106 can update the bidding algorithm associated with a contract as it receives updates to the advertisements procured and the volume of users having defined characteristics.

With a general understanding of the randomness in the bidding module, it is now logical to describe some of the functions performed by a static and dynamic bidding module. A static bidding module takes an estimation of network traffic, assumes the estimation is accurate, and bids on advertisement placements as the allocation of actual network traffic begins to deplete the number of users having defined characteristics estimated. A dynamic bidding module receives an updated advertising plan dynamically. As the number of users decreases, the bidding module may increase in aggressiveness. For example, the bidding module may increase the maximum bid amount to increase the probability the allocation associated with a given contract is satisfied. In another embodiment, the bidding module may decrease in aggressiveness.

With a general understanding of the functions performed by bidding module, it is now logical to describe the randomness of network traffic. In short, predicting the randomness in network traffic may be accomplished in communication with the optimization module 118, the forecasting module 116, any information from the data stores 108, 110, 112 or data received from the ad server 106. Given a random prediction of network traffic, denoted by N with a distribution F. Assuming allocations may be fractional, let U(T/n) denote the temporal distribution metric, where T is the target allocation.

Upon receiving updated forecasting module 116, the optimization module 118 may determine an updated advertisement plan and the bidding module may reformulate the bidding strategy for a given contract. This may be done periodically, dynamically as well as offline. In one embodiment, a high probability is implemented by overestimating target allocation, or the number of advertisement placements to be presented to users having defined characteristics. In another embodiment, a high probability is implemented by underestimating network traffic. As will be recognized by a person with skill in the art, the probability of a bidding algorithm may be altered by adjusting a variety of factors.

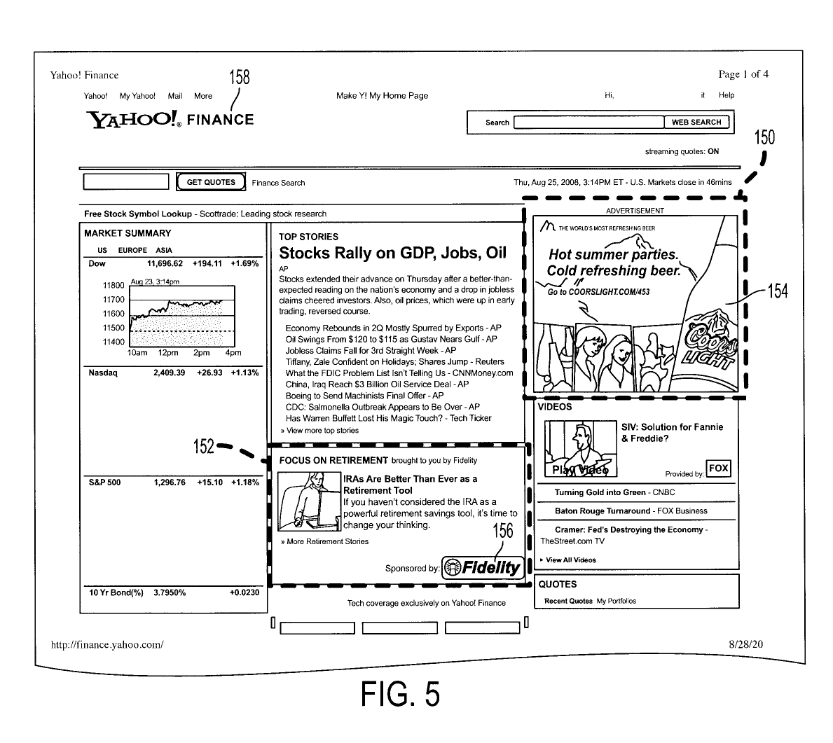

FIG. 5 illustrates a sample output display as generated by the system and method for distributing advertisements described herein. The sample output display may be generated by the advertising system 100 of FIG. 1 for display on the computer 122 via the network 120. Prior to display, the ad server 106 receives information about the user 124, recognizes that advertisement opportunities exist and conducts an electronic bidding operation for the placement of advertisements. The processing device 102 recognizes the advertisement opportunity consistent with at least one contract, such that the bidding and pricing module 114 calculates a bid amount and a corresponding bid is place in the ad server.

The sample output display of FIG. 5 includes a first advertisement placement 150 and a second advertisement placement 152, denoted by the dotted lines. These advertisement placements are directed relative to the user 124. As the sample output display may suggest, the advertisements 154 and 156 may be placed in the advertisement placements presented to users having an interest in finance 158 and sports as defined characteristics. This sample output display generated includes one advertisement from Coors Light® 154 and another sponsored by Fidelity® 156, where the advertisement 154 recognizes that the user may choose a beverage for consumption while watching a sporting event and advertisement 156 may which to entice the user 124 to explore investment opportunities with their company. As such, the output sample screen shot of FIG. 5 illustrates a representative display with advertisements selected based on the characteristics of the user and the fulfillment of corresponding advertisement contracts.

FIGS. 1 through 5 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for distributing advertisements in a network-based advertisement campaign, the method comprising:
determining a number of advertisement placements for a contract within a contract time interval, the advertisement placements each presented to users having defined characteristics;
reviewing forecasting information regarding user traffic, including forecasting information for predicting a volume of users having the defined characteristics;
in response to the forecasting information, procuring advertisement placements consistent with the contract during the contract time interval using a bidding module that adjusts a bidding algorithm to account for uncertainty in the forecasting information, including dynamically adjusting a buffer number of procured advertisement placements relative to a number of procured of advertisement placements and a time remaining of the contract time interval; and
distributing the advertisements in a network-based output.

2. The method of claim 1 wherein the defined characteristics comprise demographic information describing the users.

3. The method of claim 1 wherein procuring advertisement placements includes associating the contract with the advertisement placements.

4. The method of claim 1 further comprising:
procuring the advertisement placements during the contract time interval such that the distribution of the advertisements is in a substantially uniform manner.

5. The method of claim 1 further comprising:
adjusting price limitations for the bidding module for fulfillment of the contract.

6. The method of claim 1, wherein the volume of users relates to network-based traffic of users visiting a network location, the distribution of advertisements comprising distributing the advertisements for viewing by the users having the defined characteristics.

7. A system for distributing advertisements in a network-based advertisement campaign, the system comprising:
a computer readable medium having executable instructions stored thereon;
an advertisement information database; and
a processing device in communication with the computer readable medium operative to receive the executable instructions therefrom; the processing device, in response to the executable instructions, operative to:
determine a number of advertisement placements for a contract within a contract time interval, the advertisement placements each presented to users having defined characteristics;
review forecasting information regarding user traffic, including forecasting information for predicting a volume of users having the defined characteristics;
in response to the forecasting information, procure advertisement placements consistent with the contract during the contract time interval using a bidding module that adjusts a bidding algorithm to account for uncertainty in the forecasting information, including dynamically adjusting a buffer number of procured advertisement placements relative to a number of procured of advertisement placements and a time remaining of the contract time interval; and
distribute the advertisements in the network-based output.

8. The system of claim 7 wherein the defined characteristics comprise demographic information describing the users.

9. The system of claim 7 further comprising:
an index data store; and
the processing device, in response the executable instructions to procure advertisement placements consistent with the contract, is further operative to:
associate the contract with the advertisement placements procured; and
store one or more associations for the contract in the index data store.

10. The system of claim 7 wherein the procuring the advertisement placements during the contract time interval is such that the distribution of the advertisements is in a substantially uniform manner.

11. The system of claim 7, wherein the processing device, in response to the executable instructions, is further operative to:
adjust price limitations for the bidding module for fulfillment of the contract.

12. The system of claim 7, wherein the volume of users relates to network-based traffic of users visiting a network location, the distribution of advertisements comprising distributing the advertisements for viewing by the users having the defined characteristics.

13. Computer readable media comprising program code that when executed by a programmable processor cause execution of a method for distributing advertisements in a network-based advertisement campaign, the computer readable media comprising:
program code for determining a number of advertisement placements for a contract within a contract time interval, the advertisement placements each presented to users having defined characteristics;
program code for reviewing forecasting information regarding user traffic, including forecasting information for predicting a volume of users having the defined characteristics;
program code for procuring, in response to the forecasting information, advertisement placements consistent with the contract during the contract time interval using a bidding module that adjusts a bidding algorithm to account for uncertainty in the forecasting information, including dynamically adjusting a buffer number of procured advertisement placements relative to a number of procured of advertisement placements and a time remaining of the contract time interval; and
program code for distributing the advertisements in the network-based output.

14. The computer readable media of claim 13 wherein the defined characteristics comprise demographic information.

15. The computer readable media of claim 13 wherein the program code for procuring advertisement placements includes program code for associating the contract with the advertisement placements.

16. The computer readable media of claim 13 wherein the program code for procuring advertisement placements further comprises program code for distributing the advertisements in a substantially uniform manner.

17. The computer readable media of claim 13 further comprising:
program code for adjusting price limitations for the bidding module for fulfillment of the contract.

18. The computer readable media of claim 13, wherein the volume of users relates to network-based traffic of users visiting a network location, the distribution of advertisements comprising distributing the advertisements for viewing by the users having the defined characteristics.
